(19) United States
(12) Patent Application Publication
(10) Pub. No.: US 2011/0052379 A1
(43) Pub. Date: Mar. 3, 2011

(54) METHOD FOR MONITORING A MIXTURE OF AT LEAST TWO COMPONENTS

(75) Inventor: Torsten Link, Norden (DE)

(73) Assignee: Aloys Wobben, Aurich (DE)

(21) Appl. No.: 12/921,381

(22) PCT Filed: Mar. 9, 2009
(86) PCT No.: PCT/EP09/01671

§ 371 Date: Nov. 16, 2010

(30) Foreign Application Priority Data
Mar. 7, 2008 (DE) 10 2008 013 170.9

(51) Int. Cl. F03D 11/00; B01F 15/04

(52) U.S. Cl. 415/182.1; 366/142; 416/223 R

(57) ABSTRACT

Provided is a method and apparatus for monitoring a mixture of at least two components. Also provided is a rotor blade of a wind power installation, a gondola casing of a wind power installation and a wind power installation itself. To provide a method in which the composition of the mixture can be easily monitored without damaging the workpiece produced therefrom, a dye is added to each component, wherein added to each component is its own color which is different from that of the other components, and the mixture of those components is monitored colorimetrically. A gondola casing and/or a rotor blade is manufactured by using such a method to determine amounts of components to include in a material of which the gondola casing or rotor blade is to be made.

### BACKGROUND

1. Technical Field

The present disclosure concerns a method of monitoring a mixture of at least two components as well as a rotor blade of a wind power installation, a gondola casing of a wind power installation and a wind power installation itself. The present disclosure further concerns an apparatus for mixing at least two components.

2. Description of the Related Art

In particular rotor blades and gondola casings of wind power installations are frequently made from glass fiber-reinforced plastic materials or also carbon fiber-reinforced plastic materials. Those plastic materials are resins to which hardeners or hardening agents have to be added in a predetermined mixing ratio so that those resins set during the production procedure in the desired time and have the desired material properties.

As the mechanical properties of the components produced with such resins should observe predetermined conditions it is desirable in relation to quality-assurance aspects that it is possible to check the correct mixing ratio.

In the state of the art that is effected by taking a material sample from the hardened material, that sample then being chemically analyzed to determine its composition. It will be noted however that, due to the sampling operation, that method necessarily results in damage to the workpiece made therefrom. In addition the chemical analysis uses some time and in the event of considerable deviations from the desired material properties, almost the only possible option that remains is to destroy the workpiece that has already been produced.

### BRIEF SUMMARY

Therefore, one embodiment is to provide a method with which the composition of the mixture can be easily monitored without damaging the workpiece.

Thus there is provided in one embodiment a method of monitoring a mixture of at least two components with differing action. A dye is added to at least one of the components. The dye of each component differs from the dye of another component in respect of its color. The mixture of the two components (with the added dyes) is monitored colorimetrically.

For that purpose a dye is added to at least two components. Each component has a different action. Added to each component is a dye which is specific thereto and which is different from that of the other components, and the mixture of those components is colorimetrically monitored.

In that respect particular embodiments may be based on the realization that the addition of dye with the correct mixing ratio results in a quite specific color in the mixture, which can be very precisely monitored by colorimetric investigations. Even minor deviations in the mixing ratio of the color or the dye can be detected by colorimetric investigations. Thus the mixture produced can already be monitored before processing and possibly or optionally the desired mixing result can even be produced after a further mixing operation by subsequent addition of a component so that the mixture always involves the correct mixing ratio when it is subjected to further processing.

According to an embodiment of the method described above, determined colors are added to the components. The colors may be predetermined. That facilitates a standardization effect which is highly advantageous for industrial application. That equally applies to amounts of dye.

In order to be able to particularly well recognize deviations from the desired mixing ratio preferably complementary colors are added to the components. Alternatively however it is also possible to associate with the components colors in accordance with a desired mixing result so that the mixture has a determined coloration. That is advantageous if the surfaces produced are to be of a given color.

With the method according to an embodiment, it is advantageously possible to mix resin and hardener but also filler material and hardener or components of an adhesive, and the mixing ratio can be very accurately monitored.

It is precisely for parts of capital expenditure items that reliable quality monitoring is desired because in such a context this can quickly involve large amounts of money if unexpected and still more unwanted damage occurs. Naturally safety aspects also play a part which is in no way to be underestimated.

A rotor blade of a wind power installation or also a gondola casing of a wind power installation may be produced using at least one mixture produced in accordance with a method as described above. A wind power installation may be equipped with at least one such rotor blade or such a gondola casing or other components.

Effective utilization of colorimetric monitoring can be implemented by an apparatus for mixing at least two components. The apparatus includes supply containers for each component, conveyors with which a determined amount of the respective components is taken from each supply container and fed to a mixer, wherein a colorimetric arrangement is provided for colorimetric monitoring of the mixture produced by the mixer from the components.

In one embodiment the apparatus includes a first signal section for influencing of the conveyors by the colorimetric arrangement. In that way, when a deviation in the color of the mixture is detected by the colorimetric arrangement, the corresponding conveyor can be influenced in such a way that the mixture remains processable if the deviations can be kept within the tolerance range. In that way that apparatus always provides an appropriate mixture of the components.

So that, in the event of an excessively large deviation in the color of the mixture, that is to say a change which can no longer be tolerated in the mixture itself, the mixture does not pass into the processing procedure, the apparatus according to one embodiment particularly includes a switching-over arrangement for influencing the conveyor path of the mixture.

By means of that switching-over arrangement the unusable mixture can be fed for example to a collecting container and then disposed of in a substantively and environmentally appropriate fashion. As soon as the mixing ratio is within the tolerance range again the switching-over arrangement can again set the conveyor path in such a way that the mixture is fed to the processing operation. That therefore implements not just automatic monitoring but also automatic elimination of an unusable mixture.

Particularly the switching-over arrangement can be influenced by way of a second signal section and can thus receive signals from the colorimetric arrangement in order to separate out the mixture or pass it to the processing operation in accordance with the signals. In that case the switching-over arrangement can also be integrated in the colorimetric arrangement.

### BRIEF DESCRIPTION OF THE SEVERAL VIEWS OF THE DRAWINGS

Various embodiments are described in greater detail hereinafter. In the drawings:

FIG. 1 shows a view of a mixing installation,

FIG. 2 shows a view of the mixing installation with a colorimetric arrangement,

FIG. 3 shows a view of a further mixing installation,

FIG. 4 shows a view of an alternative embodiment of the mixing installation of FIG. 3, and

FIG. 5 is a chart showing a characteristic from which the deviation from a determined reference value can be determined.

### DETAILED DESCRIPTION

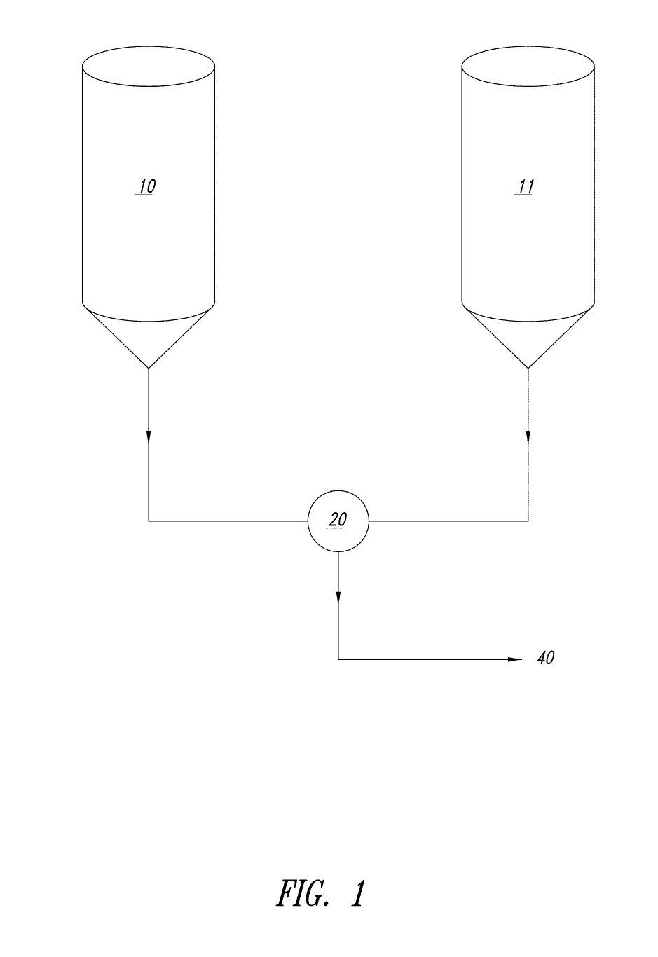

The mixing installation shown in greatly simplified form in FIG. 1 is known in the state of the art. References 10 and 11 denote containers with the supply of the respective component. From that component supply in the containers 10, 11 the determined amounts are fed to a mixer 20 which mixes the components. The mixture can then be fed from the mixer 20 to the processing operation.

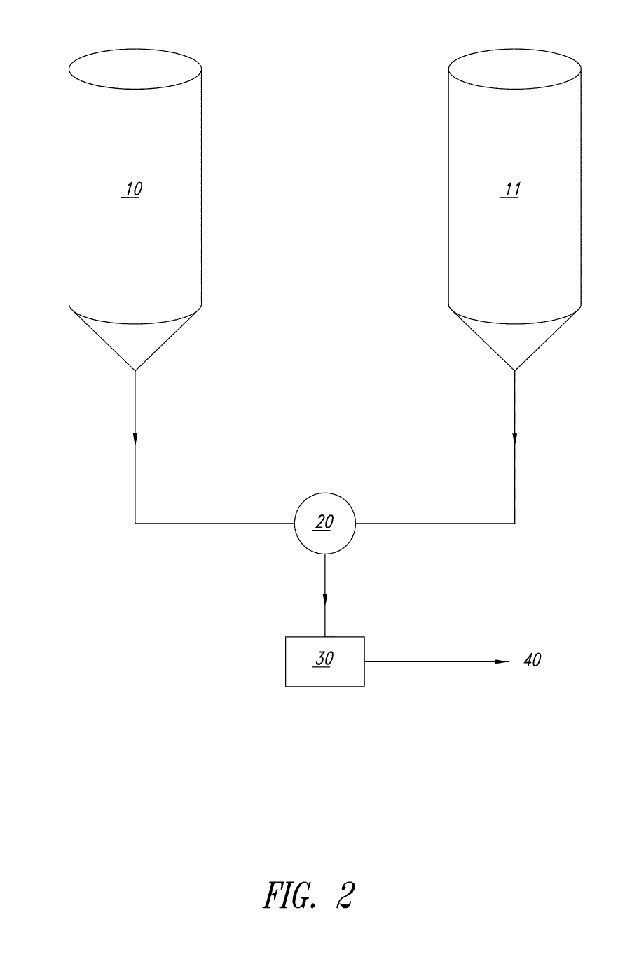

FIG. 2 shows the mixing installation which has already been described with reference to FIG. 1, supplemented by a colorimetric arrangement 30. That colorimetric arrangement 30 monitors continuously or at intervals the color of the mixture of the components from the containers 10, 11 and thus (indirectly) the mixing ratio of the components supplied from the supply containers 10, 11. In that case mixing of the components (for example plastic material, resin, filler material and hardener or hardening agent) from the containers 10, 11 can be effected. Alternatively thereto dyes can be added to at least one component and colorimetric detection can be effected.

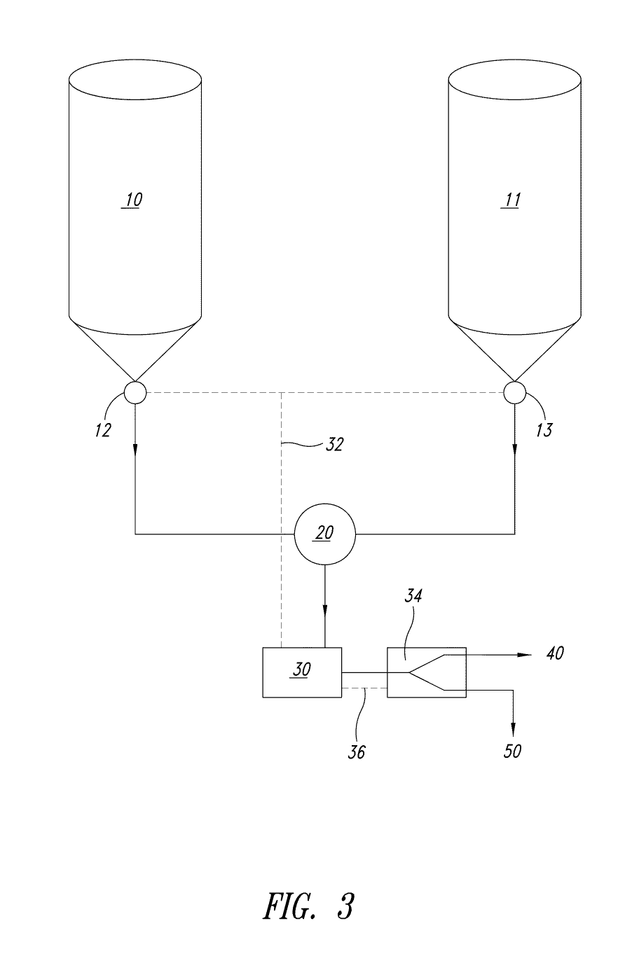

FIG. 3 shows a further embodiment, for example based on the FIG. 2 installation. In this Figure a conveyor 12 is associated with the supply container 10 and a conveyor 13 is associated with the supply container 11. A first signal section 32 is illustrated between the conveyors 12, 13 and the colorimetric arrangement 30. As soon as the colorimetric arrangement 30 recognizes deviations from the determined reference value of the color of the mixture it can influence the respective conveyor 12, 13 by way of that first signal section 32 and thus can adjust the desired color of the mixture and accordingly an optimum mixing ratio, by way of adaptation of the conveyed amount.

There is additionally provided a switching-over arrangement 34 connected to the colorimetric arrangement 30 by way of a second signal section 36. When the colorimetric arrangement 30 detects that the color of the mixture is outside the tolerance range then it can influence the switching-over arrangement 34 by way of the second signal section 36 in such a way that that mixture is not passed to the production 40 but by way of a different conveyor path 50 is for example collected and disposed of in substantively and environmentally appropriate fashion. As soon as the colorimetric arrangement 30 detects the correct color and thus the correct mixing ratio again it can again influence the switching-over arrangement 34 by way of the second signal section 36 to pass the mixture to the production 40 again.

Like the signal section 32 already described hereinbefore the second signal section 36 can be for example a wired but also a wireless connection, by way of which signals can be exchanged.

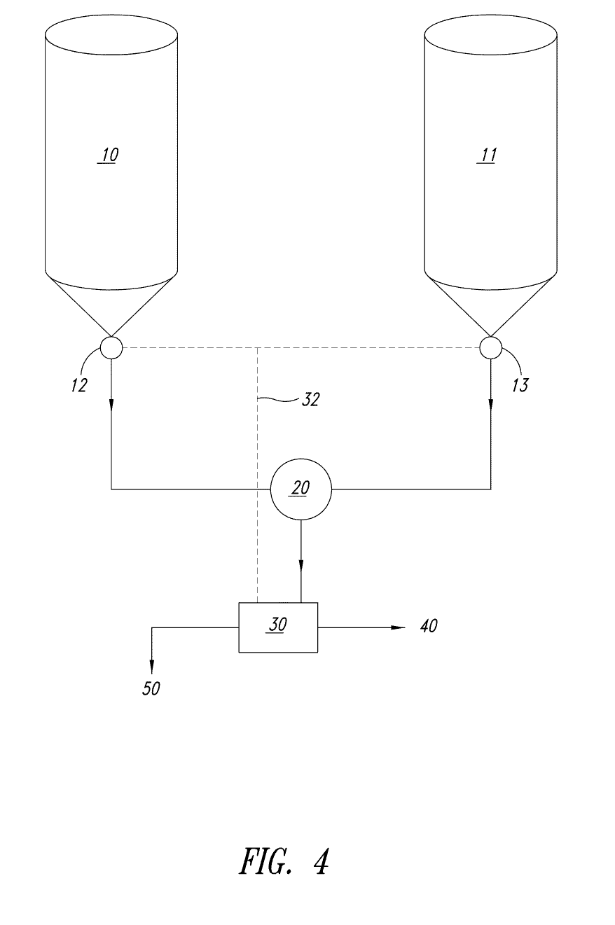

In an alternative embodiment FIG. 4 shows an arrangement in which the switching-over arrangement is integrated into the colorimetric arrangement 30.

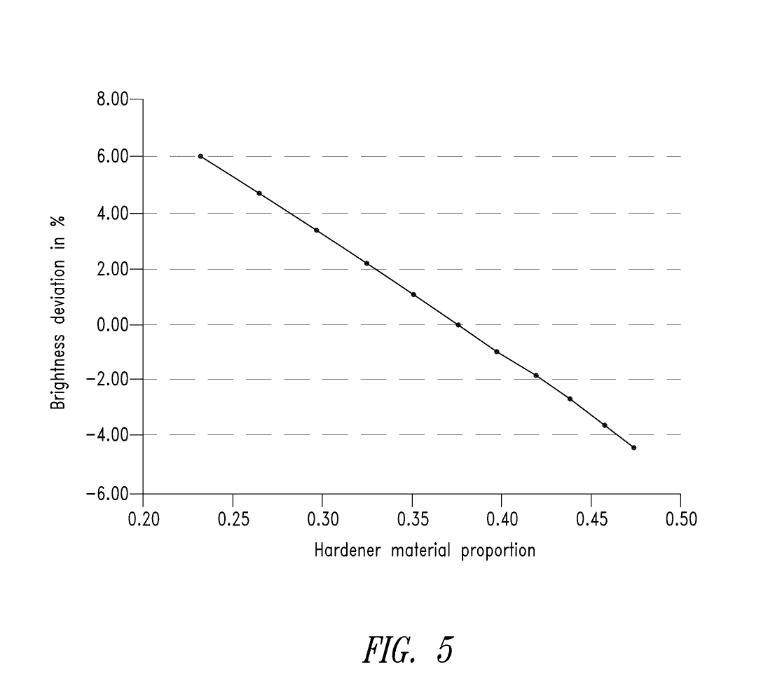

The mode of operation of colorimetric monitoring will now be described in greater detail with reference to an example shown in FIG. 5. The hardener material proportion is specified on the abscissa in this Figure. This ranges from 0.20 to 0.50. This means that hardener of a proportion of 20-50% in the mixing ratio is illustrated in this Figure. The ordinate gives the brightness deviation of the color in %. In this respect the determined reference value is marked by 0.00, for if there is no brightness deviation then the color is exactly the desired color. The mixing ratio therefore exactly corresponds to the preset values. That color occurs at a hardener material proportion of about 0.375. If now the hardener material proportion varies then the color brightness changes and the hardener material proportion can be inferred from the change in the color brightness.

The characteristic curve of an example illustrated here applies to a black-colored hardener, for a white-colored resin. If the hardener material proportion increases then the brightness of the mixture decreases and the brightness deviation involves a negative sign. With a hardener material proportion of about 0.42, that involves a brightness deviation of −2%. Accordingly a brightness deviation of +2% in color occurs with a lower hardener material proportion of about 0.325.

Naturally depending on the respective colors selected it is possible not only to monitor the brightness deviation but also other measurable values in the color coordinate system such as for example the red-green change or the yellow-blue change. Thus the mixing ratio can be easily monitored and possibly suitably corrected by a suitable selection of the colorimetrically monitored parameters.

The color or dyes added to the components in the containers 10, 11 can also contain luminescent or phosphorescent dyes.

Besides a colorimetric arrangement which is of the arrangement and configuration as described hereinbefore it will be appreciated that it is also possible to colorimetrically investigate the finished product such as for example a rotor blade for a wind power installation. That can also happen in an ongoing production process in order for example to monitor the production quality in a random sample procedure. Mobile colorimetric arrangements can be used for that purpose.

The above-described components are different from the dyes. Complementary colors when mixed afford a grey shade and in the extreme case black or white. On a color circle complementary colors are at the corners of a regular n-gon, wherein n signifies the number of the components of the colors.

As an alternative to the above-described embodiment each of the components used can have a given color shade so that colorimetric monitoring of a mixture of the components can be effected even without an addition of further dyes.

Alternatively thereto it may be sufficient for a dye to be added to only one component while the other component does not have any further added dye. Mixing of the two components involves a change in the color of the mixture in comparison with the colors of the components.

In that respect the components can represent plastic material, in particular resin as well as hardeners or hardening agents, filler material and hardener or hardening agent and constituents of an adhesive.

Colorimetric investigation by the colorimetric arrangement 30 can be effected for example on the basis of the Lambert-Beer law, in which case measurement is then limited to a monochromatic measurement. Measurement of the colors or the color valences can be effected by an equality method, a brightness method and/or a spectral method. In the case of the equality method the color of the mixture can be compared to a large number of known standard patterns until the two colors are identical. The brightness method involves effecting optical detection of the color with downstream-connected color filters. Alternatively or additionally thereto it is possible to use color sensors. The spectral method involves spectral analysis of the colors. That can be effected for example by a spectrometer.

By means of the above-described method of monitoring a mixture of two components, it is possible for example to effect quality checking in the production of rotor blades. Such quality checking is effected in a biometric procedure and can thus be implemented without taking material, as a non-destructive testing operation. Such quality checking can also be carried out after manufacture of the rotor blades has been effected.

In accordance with a further embodiment, a rotor blade of a wind power installation can be at least partially made from a material stock Bergolin 6D970-7038 SPR, color shade white, and a material hardener Bergolin 7D202-SW-R, color shade black. The reference weight ratio is 100:60. The reference color shade of the mixture can represent about RAL 7038 agate grey. A BYK-Gardener “Spectro-guide sphere gloss” can be used as the color shade measuring unit.

The maximum permitted range of fluctuation in the weight ratio in relation to the material stock relative to the material hardener has a maximum super-crosslinking of 100:62.4 and a minimum sub-crosslinking of 100:57.6, that is to say as a weight proportion maximum super-crosslinked (upper tolerance limit) 62.4/(100+62.4)=38.4% and minimum sub-crosslinked (lower tolerance limit) 57.6/(57.6+100)=36.5%. There is thus a permitted range of fluctuation of 1.9% hardener mass proportion in the mixture.

The color shade changes can be measured in dependence on the hardener proportion and are shown in Table 1. That relationship can be described by the function dL=−11.871x2−34.427x+14.656 (see column dL supplemented polynomial).

The above-described dL refers to a color shade change and in particular to the CIELAB brightness difference. In DIN 6174: 2007, page 5, point 4, Determining the color co-ordinates of the CIE 1976 (L*a*b*) color space a representation is effected between the standard color values X, Y, Z in accordance with DIN 5033-2 and the color co-ordinates of the approximately uniform CIE 1976 (L*a*b*) color space, for brevity the CIELAB color space, in the right-angled co-ordinates L* (brightness), a* (red-green axis) and b* (yellow-blue axis).

TABLE 1

| | Hardener | dL | dL | |
|---|---|---|---|---|
| MR | material | labora- | supplemented | |
| (mass) | proportion x | tory | polynomial | |
| 100:90 | 0.474 | −4.34 | −4.32 | measurement value |
| 100.84 | 0.457 | −3.52 | −3.53 | measurement value |
| 100:78 | 0.438 | −2.65 | −2.71 | measurement value |
| 100:72 | 0.419 | −1.80 | −1.84 | measurement value |
| 100:66 | 0.398 | −0.96 | −0.91 | measurement value |
| 100:62.4 | 0.384 | | −0.32 | upper allowed |
| | | | | limit fluctuation |
| | | | | range hardener |
| | | | | material proportion |
| 100:60.4 | 0.377 | | 0.009 | volumetric |
| | | | | measurement result |
| 100:60 | 0.375 | 0.00 | | =reference value, |
| | | | | absolute color shade |
| | | | | co-ordinates: |
| | | | | L = 70.27, |
| | | | | a = −1.10, b = 1.94 |
| 100:57.6 | 0.365 | | 0.49 | lower allowed limit |
| | | | | fluctuation range |
| | | | | hardener material |
| | | | | proportion |
| 100:54 | 0.351 | 1.08 | 1.12 | measurement value |
| 100:48 | 0.324 | 2.25 | 2.24 | measurement value |
| 100:42 | 0.296 | 3.50 | 3.43 | measurement value |
| 100:36 | 0.265 | 4.80 | 4.71 | measurement value |
| 100:30 | 0.231 | 6.00 | 6.08 | measurement value, |
| | | | | an article was used |
| | | | | here, the sample |
| | | | | stuck |

In the case of such a rotor blade the following overall entirety can be measured (Table 2):

TABLE 2
L-values V5 at 060208, optimized after volumetric measurement
70.62
70.65
70.54
70.64
70.51
70.51
70.64
70.60
70.74
70.56
70.59
70.60
70.66
70.73
70.65
70.57
70.39
70.54
70.46
70.53
70.54
70.50
70.57
70.58
70.58
70.81
70.67
70.45
70.40
70.44
70.63
70.44
70.40
70.43
70.51
70.54
70.59
70.50
70.41
70.58
70.63
70.68
70.58
70.66
70.63
70.50
70.60
70.61
70.58
70.66

The greatest value was L=70.81 and the smallest was L=70.39, that is to say the distribution has a standard deviation of L=±0.093.

If based on the above relationship (Table 1) the inverse function is formed, then for that value there follows a corresponding one for the hardener material proportion standard deviation of ±0,21%.

x=−0.0001 dL²−0.0231 dL+0.3768

The effective weight ratio central layer was subjected to volumetric measurement at 100:60.4. That corresponds to a hardener material proportion of x=60.4/(100+60.4)=37.7%.

If a chemical analysis had been carried out the measurement would be effected with a measurement accuracy of ±1% to try to demonstrate an existing fluctuation range of ±1%. The methods according to various embodiments described herein are non-destructive and can be rapidly evaluated. The above-described statistical information is provided by the measurement methods according to the various embodiments described herein.

The various embodiments described above can be combined to provide further embodiments. All of the U.S. patents, U.S. patent application publications, U.S. patent application, foreign patents, foreign patent application and non-patent publications referred to in this specification and/or listed in the Application Data Sheet are incorporated herein by reference, in their entirety. Aspects of the embodiments can be modified, if necessary to employ concepts of the various patents, application and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method comprising:
adding a dye to at least one of at least two components of a mixture that have different actions in the mixture, wherein each added dye has a different color from a color of any such added dye in another component of the at least two components; and
monitoring the mixture colorimetrically.

2. The method of claim 1 wherein each added dye is of a determined color.

3. The method of claim 1 wherein an amount of each added dye is determined.

4. The method of claim 1 wherein colors of each added dye are complementary colors.

5. The method of claim 1 wherein the different colors of each added dye are selected such that a desired mixing result is achieved after mixing of the at least two components.

6. The method of claim 1 wherein one of the at least two components is a resin and another of the at least two components is a hardener or hardening agent.

7. The method of claim 1 wherein one of the at least two components is a filler and another of the at least two components is a hardener or a hardening agent.

8. The method of claim 1 wherein the at least two components are constituents of an adhesive.

9. A rotor blade for a wind power installation manufactured by using the process of claim 1 to determine amounts of components to include in a material of which the rotor blade is to be made.

10. A wind power installation having at least one rotor blade that is manufactured by using the process of claim 1 to determine amounts of components to include in a material of which the rotor blade is to be made.

11. An apparatus for mixing at least two components having different actions, comprising:
at least a first supply container for a first component of the at least two components and a second supply container for a second component of the at least two components;
at least a first and a second conveyor configured to feed a first amount of the first component and a second amount of the second component to a mixer in order to produce a mixture of the at least two components; and
colorimetric arrangement configured to colorimetrically monitor the mixture of the at least two components.

12. The apparatus of claim 11 wherein at least one of the first and second components includes an added dye.

13. The apparatus of claim 11 further comprising a first signal section that is in operable communication with the conveyors and the colorimetric arrangement and is configured to influence the conveyors by using signals from the colorimetric arrangement or by using signals from a switching-over arrangement that is in operable communication with the colorimetric arrangement and that is configured to influence a conveyor path of the mixture.

14. The apparatus of claim 13 further comprising a second signal section that is in operable communication with the switching-over arrangement and the colorimetric arrangement and is configured to influence the switching-over arrangement.

15. The apparatus of claim 13 wherein the switching-over arrangement is integrated with the colorimetric arrangement.

16. A method of setting a mixing ratio of at least two components having different actions, the method comprising
providing the at least two components, wherein at least one of the components contains a preselected concentration of a dye; and
mixing the at least two components to give a mixture, wherein color intensities of the one or more dyes of the at leak two components are detected during the mixing; and
metering further amounts of the at least two components in accordance with the detected color intensities for further mixing of the at least two components.

17. The method of claim 16 wherein colors of dyes which have been added to respective components of the at least two components behave as complementary colors relative to each other.

18. The method of claim 16 wherein one of the at least two components is a resin or a filler and another of the at least two components is a hardener.

19. The method of claim 16 wherein the at least two components are different from the dyes.

20. A gondola casing for a wind power installation manufactured by using the process of claim 1 to determine amounts of components to include in a material of which the gondola casing is to be made.

21. A wind power installation having a gondola casing that is manufactured by using the process of claim 1 to determine amounts of components to include in a material of which the gondola casing is to be made.
